(19) United States
(12) Patent Application Publication
(10) Pub. No.: US 2011/0228423 A1
(43) Pub. Date: Sep. 22, 2011

(54) MAGNETIC RECORDING HEAD, MAGNETIC HEAD ASSEMBLY, AND MAGNETIC RECORDING/REPRODUCING APPARATUS

(75) Inventors: Katsuhiko Koui, Tokyo (JP); Kenichiro Yamada, Tokyo (JP); Mariko Kitazaki, Kanagawa-ken (JP); Hitoshi Iwasaki, Tokyo (JP); Masayuki Takagishi, Tokyo (JP); Tomomi Funayama, Tokyo (JP); Masahiro Takashita, Kanagawa-ken (JP); Soichi Oikawa, Tokyo (JP)

(73) Assignee: KABUSHIKI KAISHA TOSHIBA, Tokyo (JP)

(21) Appl. No.: 12/880,676

(22) Filed: Sep. 13, 2010

(30) Foreign Application Priority Data
Mar. 17, 2010 (JP) 2010-061663

(51) Int. Cl. G11B 5/127; G11B 5/48; G11B 21/02

(52) U.S. Cl. 360/75; 360/110; 360/246.2; G9B/5.147; G9B/5.04; G9B/21.003

(57) ABSTRACT

A magnetic recording head includes a first ferromagnetic layer, an intermediate layer, a third ferromagnetic layer, a first magnetic pole and a second magnetic pole. The intermediate layer is provided between the first ferromagnetic layer and the second ferromagnetic layer. The third ferromagnetic layer includes a CoIr alloy and is provided so that the first ferromagnetic layer is sandwiched between the third ferromagnetic layer and the intermediate layer. The first magnetic pole is provided so that the third ferromagnetic layer is sandwiched between the first magnetic pole and the first ferromagnetic layer. The second magnetic pole is provided so that the second ferromagnetic layer is sandwiched between the second magnetic pole and the intermediate layer.

### CROSS REFERENCE TO RELATED APPLICATION

This application is based upon and claims the benefit of priority from the prior Japanese Patent Application No. 2010-061663, filed on Mar. 17, 2010, the entire contents of which are incorporated herein by reference.

### FIELD

Embodiments relate generally to a magnetic recording head, a magnetic head assembly, and a magnetic recording/reproducing apparatus.

### BACKGROUND

A magnetic recording head is disclosed, which is provided with an oscillation layer, a spin injection layer, a nonmagnetic layer provided between the oscillation layer and the spin injection layer, in a published US patent application 2008/0137224. Both the oscillation layer and the spin injection layer include an alloy selected from the group consisting of Co, CoFe, CoFeB, and NiFe.

However, it is required to increase a drive current which passes through the magnetic recording head in order to heighten an oscillation frequency using the above-mentioned alloys. In addition, there is a possibility that increasing the drive current leads to an interdiffusion of elements included in the oscillation layer and the spin injection layer. Furthermore, the magnetization of the oscillation layer oscillates only in a particular direction, thereby making it impossible to efficiently generate a radio frequency magnetic field (Hac). The “radio frequency” is referred to as “RF” below.

Then, a spin torque oscillator has been proposed, which employs an oscillation layer having negative uniaxial in-plane magnetic anisotropy, in order to reduce the drive current. The “negative uniaxial in-plane magnetic anisotropy” has an easy axis of magnetization arising from magnetic crystalline anisotropy to lie in a film plane parallel to the oscillation layer. In addition, the easy axis is not in a particular in-plane direction within the film plane.

However, when a material having negative uniaxial in-plane magnetic anisotropy is employed for the oscillation layer itself, a spin torque effect of the oscillation layer is reduced as a result of a spin scattering due to a spin orbit interaction.

### BRIEF DESCRIPTION OF DRAWINGS

Aspects of this disclosure will become apparent upon reading the following detailed description and upon reference to accompanying drawings. The description and the associated drawings are provided to illustrate embodiments of the invention and not limited to the scope of the invention.

FIG. 1 is a view showing a magnetic recording head and a magnetic recording medium according to a first embodiment.

FIG. 2 is a view showing a head slider carrying the magnetic recording head according to the first embodiment.

FIG. 3 is a view showing a composition of a magnetic recording head portion.

FIG. 4 shows a view showing a write head portion viewed perpendicularly from a surface of the magnetic recording medium.

FIG. 5 is a view showing a write head portion of a magnetic recording head according to a second embodiment, which is viewed perpendicularly from a surface of the magnetic recording medium.

FIG. 6 is a graph showing a simulation for current-density dependence of a relation between an oscillation frequency inside a spin torque oscillator and an RF magnetic field generated by the spin torque oscillator of a first example of the magnetic recording head according to the first embodiment.

FIG. 7 is a graph showing a simulation for current-density dependence of a relation between an oscillation frequency inside a spin torque oscillator and an RF magnetic field generated by the spin torque oscillator of a second example of the magnetic recording head according to the first embodiment.

FIG. 8 is a graph showing a simulation for current-density dependence of a relation between an oscillation frequency inside a spin torque oscillator and an RF magnetic field generated by a spin torque oscillator of a comparative example of the magnetic recording head.

FIG. 9 is a view showing a magnetic recording/reproducing apparatus according to a third embodiment.

FIG. 10A is a perspective view illustrating a composition of a portion of the magnetic recording/reproducing apparatus according to the third embodiment.

FIG. 10B is a perspective view illustrating a magnetic head stack assembly.

FIG. 11A is a typical perspective view illustrating a composition of a magnetic recording medium for the magnetic recording/reproducing apparatus according to the third embodiment.

FIG. 11B is a typical perspective view illustrating a minute composition of the magnetic recording medium for the magnetic recording/reproducing apparatus according to the third embodiment.

FIG. 12A is a typical perspective view illustrating a composition of another magnetic recording medium for the magnetic recording/reproducing apparatus according to the third embodiment.

FIG. 12B is a typical perspective view illustrating a minute composition of the magnetic recording medium for the magnetic recording/reproducing apparatus according to the third embodiment.

### DESCRIPTION

Embodiments are explained below with reference to drawings. The drawings are conceptual. Therefore, a relationship between the thickness and width of each portion and a proportionality factor among the respective portions are not necessarily the same as an actual one therebetween. Even when the same portions are drawn, their sizes or proportionality factors are represented differently from each other with respect to the drawings. Wherever possible, the same reference numerals or marks will be used to denote the same or like portions throughout figures, and overlapped explanations are omitted in embodiments following a first embodiment.

### First Embodiment

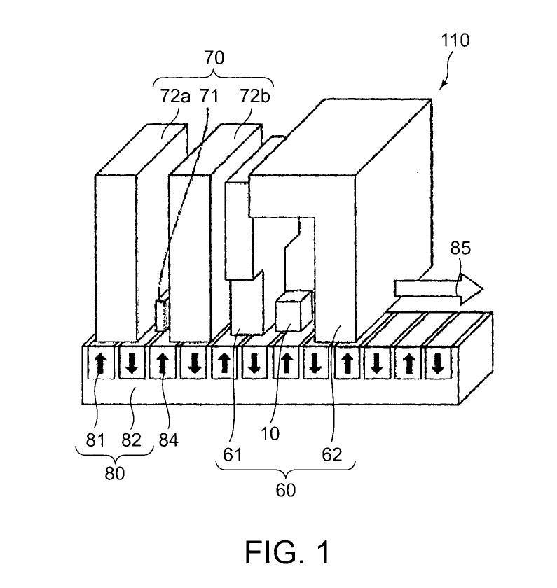

FIG. 1 is a view showing a magnetic recording head 110 and a magnetic recording medium 80 according to a first embodiment. An arrow 85 shows a direction of movement of the magnetic recording medium 80. A direction perpendicular to the arrow 85 on the surface of the magnetic recording medium 80 denotes a track width direction.

The magnetic recording head 110 according to the embodiment is provided with a read head portion 70 and a write head portion 60.

The read head portion 70 is provided with magnetic shield layers 72a and 72b. Moreover, a magnetic reproduction element 71 is further provided between the magnetic shield layers 72a and 72b.

The write head portion 60 is provided with a magnetic pole 61 (a first magnetic pole), a return path 62 (a second shield), an RF shield 63 (a first shield) 63, and a spin torque oscillator (referred to as “STO” below) 10. Moreover, the write head portion 60 is provided with a magnetizing coil (not shown).

In addition, each element which is included in both the read head portion 70 and the write head portion 60 is separated by an insulator, such as alumina (not shown).

A GMR (Giant MagnetoResistance) element, a TMR (Tunnel MagnetoResistive effect) element, etc. can be employed for the magnetic read element 71, for example. Moreover, the magnetic read element 71 is mounted between two magnetic shield layers 72a and 72b in order to improve the reproduction resolution thereof.

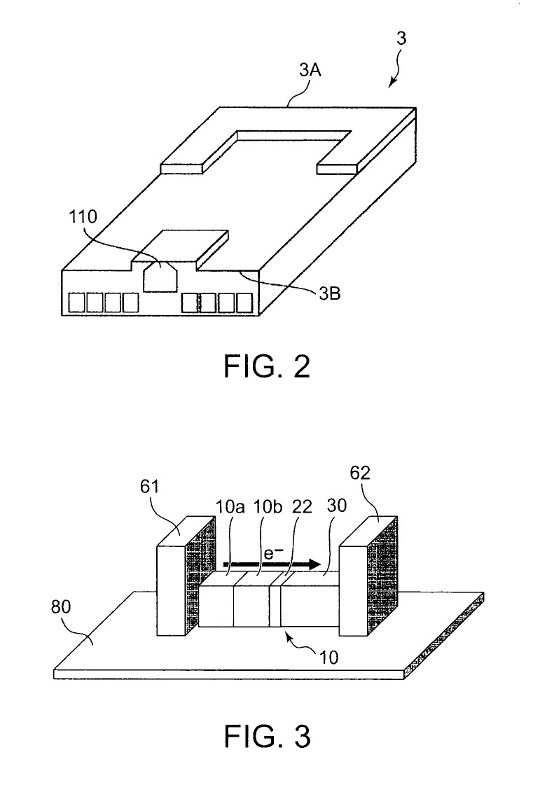

FIG. 2 is a view showing a head slider 3 carrying a magnetic recording head 110 according to this embodiment.

The head slider 3 includes Al₂O₃/TiC, etc., and is designed to be produced so that the head slider 3 is capable of moving relatively to the magnetic recording medium 80 with flying above or in contact with the magnetic recording medium 80. The head slider 3 also includes an air inflow side 3A and an air outflow side 3B. The magnetic recording head 110 is arranged on the air outflow side 3B.

The magnetic recording medium 80 has a substrate 82 and a magnetic recording layer 81 formed on the substrate 82. Writing is performed by applying a magnetic field to the magnetic recording medium 80 from the write head portion 60. Then, the magnetization of the magnetic recording layer 81 is controlled to be in a prescribed direction. Reading is performed by reading out the magnetization direction of the magnetic recording layer 81 using the read head portion 70.

FIG. 3 is a view showing a composition of the write head portion 60.

As shown in FIG. 3, STO 10 has a layered structure where oscillation layers 10a, 10b (third and first ferromagnetic layers), an intermediate layer 22 with high spin transmissivity, and a spin injection layer 30 (second ferromagnetic layer) are laminated between the magnetic pole 61 and a return path 62. Moreover, the magnetic pole 61 applies a magnetic field to STO 10, and serves as a first electrode to pass a current through STO 10 via the oscillation layer 10a (first magnetic layer). The return path 62 leads the magnetic field applied from the magnetic pole 61 thereto, and serves as a second electrode to pass a current through STO 10 via the spin injection layer 30 (second magnetic layer). Alternatively, a cap layer may be provided between the spin injection layer 30 and the return path 62. Moreover, the magnetic pole 61 and the return path 62 need not be employed as an electrode. In such a case, an electrode is provided between the magnetic pole 61 and the oscillation layer 10a, and another electrode is provided between the return path 62 and the spin injection layer 30.

STO 10 passes a driving electron current through the return path 62 (second electrode) from the magnetic pole 61 (first electrode) to generate an RF magnetic field from the oscillation layers 10a and 10b. Applying the RF magnetic field generated by STO 10 to the magnetic recording medium 80 enables RF-assist recording. In addition, the maximum current density that can be passed through STO 10 is 2×10⁸ A/cm², when the size of STO 10 is about 70 nm, for example. There is a possibility that STO 10 heats up or constituent elements of STO 10 diffuse at a current density of 2×10⁸ A/cm² or more. Therefore, it is preferable to pass a current through STO 10 at a current density as low as possible.

When a current is passed through the magnetizing coil, the write head portion 60 generates a magnetic field to perform perpendicular magnetic recording on the magnetic recording medium 80. That is, the write head portion 60 generates a magnetic field between the magnetic pole 61 and the return path 62. Furthermore, a magnetic field is applied also to STO 10. The magnetic field to be applied to STO 10 is increased to provide a higher ferromagnetic resonance frequency of the oscillation layers 10a, 10b, thereby allowing it to control the frequency of the RF magnetic field generated by STO 10. The intensity of the RF magnetic field peaks when the magnetization of the oscillation layers 10a, 10b is in a direction perpendicular to the direction of the magnetic field applied to STO 10 owing to spin torque.

The RF magnetic field generated by STO 10 localizes in an about 10 nm area near STO 10 when the size of STO 10 is tens of nanometers. Furthermore, the in-plane component of the RF magnetic field allows it to efficiently cause the ferromagnetic resonance in a perpendicularly magnetizable medium and to substantially reduce the coercivity of the magnetic recording medium 80. Here, “in-plane” means that the in-plane component is parallel to the surface of the magnetic recording medium 80. As a result, high-density magnetic recording is performed only in an area where a recording field and the RF magnetic field are superimposed on each other, provided that the recording field and the RF magnetic field are generated from the magnetic pole 61 and STO 10, respectively. This allows it to use the magnetic recording medium 80 having a high coercivity and high anisotropy energy. This also allows it to easily avoid heat fluctuation involved in high density magnetic recording.

The spin injection layer 30 and the oscillation layers 10a, 10b have coercivities lower than the magnetic field to be applied to STO 10. Therefore, an oscillation angular velocity vector of STO 10 has a polar character depending on the magnetic field to be applied to STO 10. For this reason, even if the polarity of the drive current is unchanged, the polarity of the angular velocity vector of an elliptically-polarized RF magnetic field on the magnetic recording medium 80 has the same direction as that of the recording magnetic field, thereby allowing it to perform excellent magnetic recording independently of the polar character of the writing current.

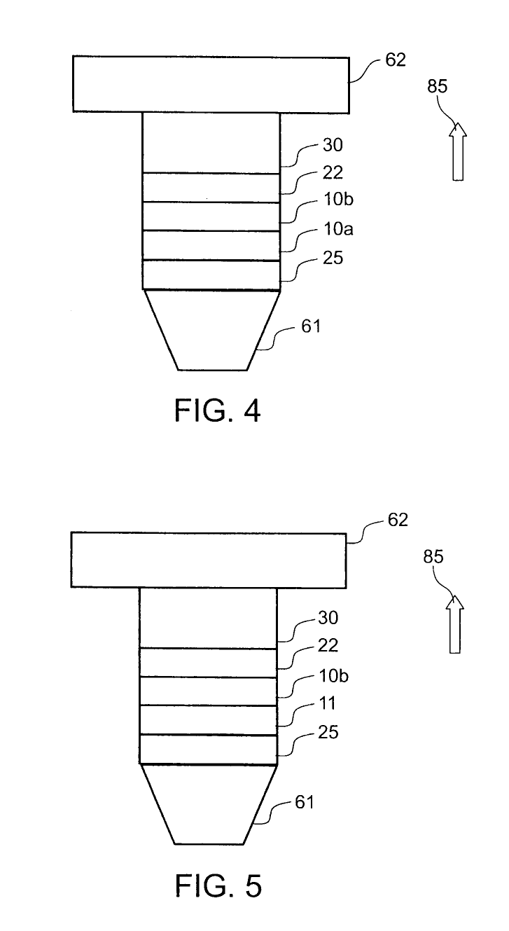

FIG. 4 shows a view showing the write head portion 60 viewed perpendicularly from the surface of the magnetic recording medium 80. That is, FIG. 4 shows a view showing a surface of the write head portion 60 facing the magnetic recording medium 80 (Air Bearing Surface: ABS surface). The arrow 85 shows a direction of movement of the magnetic recording medium 80. The return path 62 is provided in a direction perpendicular to the track width direction so that STO 10 is sandwiched between the return path 62 and the magnetic pole 61.

STO 10 is provided with an underlayer 25, the oscillation layers 10a, 10b prepared on the underlayer 25, and the spin injection layer 30 prepared on the intermediate layer 22. Alternatively, STO 10 may have a laminated structure in which the spin injection layer 30 prepared on the underlayer 25, the intermediate layer 22, and the oscillation layers 10b, 10a are laminated in this order. In this case, a driving electron flow is passed from the return path 62 toward the magnetic pole 61 to generate an RF magnetic field.

Metals, such as Ta and Ru, can be employed for the underlayer 25, for example. The thickness of the underlayer 25 is about 2 nm.

The oscillation layer 10a includes a ferromagnetic layer (a third ferromagnetic layer) with in-plane uniaxial magnetic anisotropy (negative Ku: anisotropic energy) whose easy axis of magnetization is in a plane of the oscillation layer. Specifically, a CoIr alloy can be employed for the third magnetic layer. When the CoIr alloy is used, the composition of Ir in the CoIr alloy is preferably not less than 5% and not more than 40%. When the composition of Ir in the CoIr alloy is more preferably not less than 5% and not more than 20%, the in-plane uniaxial magnetic anisotropy is stably obtained. An Fe/Co artificial lattice and a NdCo alloy can be employed as other ferromagnetic materials having negative Ku. For example, a Co/Pt artificial lattice means a lamination structure in which a Co layer with a thickness of 0.2 nm to 1 nm and a Pt layer with a thickness of 0.2 nm to 1 nm are laminated repeatedly 3 times to 6 times.

At least one metal selected from Fe, Co, and Ni can be employed for the oscillation layer 10b. These materials preferably have a crystalline structure including a body centered cubic lattice.

Since the conventional oscillation layer has magnetization not to lean in a direction perpendicular to the lamination direction thereof, it has been necessary to make the magnetization thereof precess by passing a drive current through the magnetic pole 61. However, the oscillation layer 10a according to the present embodiment is magnetically anisotropic in the plane thereof, thereby making the magnetization thereof precess by means of simply passing a small drive current through the magnetic pole 61. Furthermore, the oscillation layer 10a having in-plane magnetic anisotropy is provided independently of the oscillation layer 10b. Therefore, it is difficult to cause spin scattering due to a spin orbit interaction in the oscillation layer.

The thicknesses of the oscillation layers 10a, 10b have no upper limit. This is because only increasing the drive current theoretically allows it to make the magnetization precess. However, when designing a magnetic recording head is taken into consideration, the thicknesses of the oscillation layers 10a, 10b are preferably about 10 nm.

Here again, the thicknesses of the oscillation layers 10a, 10b are taken into consideration. For example, 10-nm thick Co₈₅Ir₁₅ and Fe₅₀Co₅₀ layers are employed for the oscillation layers 10a and 10b, respectively, to provide the whole of the oscillation layers 10a and 10b with an anisotropy field of about 2 kOe. Moreover, in order to provide the whole of the oscillation layers 10a and 10b with an anisotropy field of about 3 kOe, a 10-nm thick Co₈₅Ir₁₅ layer and a 6-nm thick Fe₅₀Co₅₀ layer are employed for the oscillation layers 10a and 10b, respectively. When the oscillation layer 10b with a thickness of not more than 2 nm is formed and the oscillation layer 10a with a thickness of 10 nm or more is made of a magnetic material having negative magnetic anisotropy, the magnetic anisotropy of the oscillation layer 10a is dominant in the magnetic anisotropy of the whole of the oscillation layers 10a, 10b substantially.

Nonmagnetic metals, such as Cu, Al, Au, Ag, Pd, Os, Ir, etc. can be employed for the intermediate layer 22, for example. The thickness of the intermediate layer 22 is not less than 2 nm and not more than 10 nm, for example.

The spin injection layer 30 is made of a magnetic material having uniaxial magnetic anisotropy in the lamination direction thereof. Thereby, when a drive current is passed from the return path 62 toward the magnetic pole 61, torque is generated to make the magnetization directions of the oscillation layers 10a, 10b parallel to the layer planes thereof. A CoPt alloy, a Co/Pt artificial lattice, a Co/Ni artificial lattice, a Co/Pd artificial lattice, etc. can be employed for the spin injection layer 30. Here, “/” denotes laminating repeatedly 3 times to 6 times. The thickness of the spin injection layer 30 is 15 nm, for example.

In addition, the anisotropy field of the spin injection layer 30 is preferably lower than the magnetic field returned to the return path 62 from the magnetic pole 61. This is to make the magnetic field direction in the spin injection layer 30 easily change in response to the magnetic field returned from the magnetic pole 61 to the return path 62. Specifically, it is desirable that the anisotropy field of the spin injection layer 30 is not less than 8 kOe and not more than 20 kOe.

In order to make the magnetic recording medium 80 resonate fully with an RF magnetic field, it is preferable to increase as much as possible the intensity of the in-plane component of the RF magnetic field within STO 10 in comparison with the anisotropy field of the magnetic recording medium 80. Methods for increasing the intensity of the in-plane component of the RF magnetic field include the followings:

increasing the saturation magnetization of the oscillation layer 10a;
thickening the oscillation layer 10a; and
increasing a deflection angle of the magnetization precession motion in the oscillation layer 10a.
However, these methods involve increasing the drive current.

In addition, the frequency of the RF magnetic field is optimized in accordance with the anisotropy field of the magnetic recording medium 80. For example, a frequency of 20 GHz to 30 GHz is needed for the magnetic recording medium 80 having an anisotropy field of 15 keO, for example. In order to oscillate at a frequency of this level, it is necessary to further increase the magnetic field applied to STO 10. The larger the magnetic field applied to STO 10 is, the larger the drive current is required in order to change the magnetization direction of the oscillation layer 10a in a direction perpendicular to the direction of the magnetic field applied to STO 10.

STO 10 according to this embodiment allows it to generate an RF magnetic field with a small drive current. Furthermore, STO 10 driven with such a small current according to this embodiment provides a magnetic recording head capable of efficiently reading/writing with respect to magnetization directions.

### Second Embodiment

FIG. 5 is a view showing a write head portion 60 of a magnetic recording head according to a second embodiment, which is viewed perpendicularly from the surface of the magnetic recording medium 80. That is, FIG. 5 shows the air-bearing surface of the write head portion 60.

The second embodiment is different from the first embodiment in that an antiferromagnetic layer 11 is provided between the underlayer 25 and the oscillation layer 10b.

A Mn alloy can be employed for the antiferromagnetic layer 11. Examples of the Mn alloy include IrMn, PtMn, NiMn, FeMn, RhMn, etc.

Employing the antiferromagnetic layer 11 provides the oscillation layer 10b with a magnetic exchange coupling bias. In order to provide the oscillation layer 10b with such an exchange coupling bias, it is necessary to prepare the antiferromagnetic layer 11 in an in-plane magnetic field parallel thereto. In this case, when the in-plane magnetic field is applied in a particular direction, the antiferromagnetic layer 11 is biased toward the particular direction owing to the exchange coupling, thereby leading to impossibility of a smooth magnetization precession motion therein. Therefore, it is preferable to apply a rotating magnetic field during the deposition of the antiferromagnetic layer 11 as the rotating magnetic field changes its direction anywhere in the plane thereof. Alternatively, after preparing the underlayer 4, the antiferromagnetic layer 11, the oscillation layer 10b, the intermediate layer 22 and the spin injection layer 30 in series, these layers may be heat-treated at about 300° C. in the rotating magnetic field to be provided with the in-plane magnetic exchange coupling bias.

The film thickness of the antiferromagnetic layer 11 is determined according to an intensity of the exchange coupling bias. When this point is taken into consideration, it is preferable that the thickness of the antiferromagnetic layer 11 is 5 nm or more. For example, in order to provide the oscillation layer 10b with a negative anisotropy field of 2 kOe, a 5 nm thick FeCo film and a 5 nm thick IrMn film are employed for the oscillation layer 10b and the antiferromagnetic layer 11, respectively.

### First Example

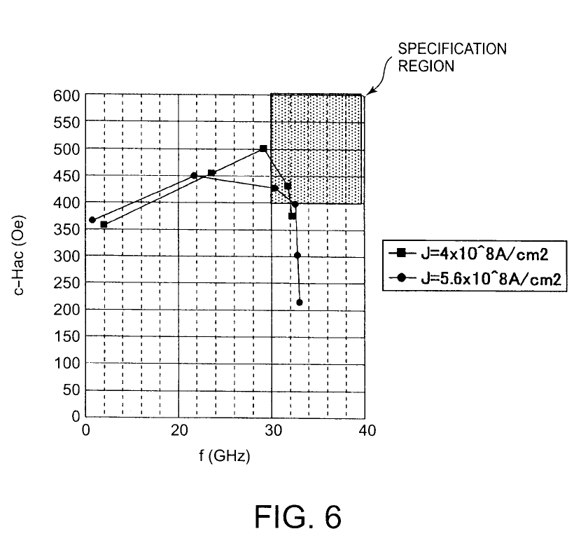

FIG. 6 is a graph showing a simulation for current-density dependence of a relation between an oscillation frequency inside STO 10 and the RF magnetic field generated by STO 10. The current-density dependence is simulated on the magnetic recording head 60 which is provided with STO 10 according to the first embodiment. The vertical and horizontal axes represent the RF magnetic field c-Hac (Oe) and the oscillation frequency f (GHz), respectively.

It is assumed in the simulation that STO 10 is provided with the spin injection layer 30, the intermediate layer 22, and the oscillation layers 10a, 10b.

Specifically, the following layers are assumed to be successively laminated to provide STO 10:

a 0.2 nm thick Co layer and a 0.6 nm thick Ni layer are laminated repeatedly 18 times for the spin injection layer 30;
a 3 nm thick Cu layer is provided in contact with the spin injection layer 30 for the intermediate layer 22;
a 1 nm thick FeCo layer is provided in contact with the intermediate layer 22 for the oscillation layer 10a; and
a 16 nm thick Ir₁₅Mn₈₅ layer is provided in contact with the oscillation layer 10a for the oscillation layer 10b.
The width of STO 10 in a direction perpendicular to the lamination direction of STO 10 is assumed to be 33 nm. The distance between the magnetic recording medium 80 and STO 10 is assumed to be 17.5 nm. The above-mentioned structure of STO 10 provides the oscillation layer 10b with an anisotropy field of 3 kOe.

An RF magnetic field frequency of 30 GHz or more is required for the magnetic recording medium to be a hard disk. Then, an RF magnetic field of 400 Oe or more is required. The shaded region in FIG. 6 shows the specification region mentioned above.

In this example, passing a current density of 4×10⁸ A/cm² through STO 10 provides an RF magnetic field c-Hac (Oe) and an oscillation frequency f (GHz) both belong to the specification region.

### Example 2

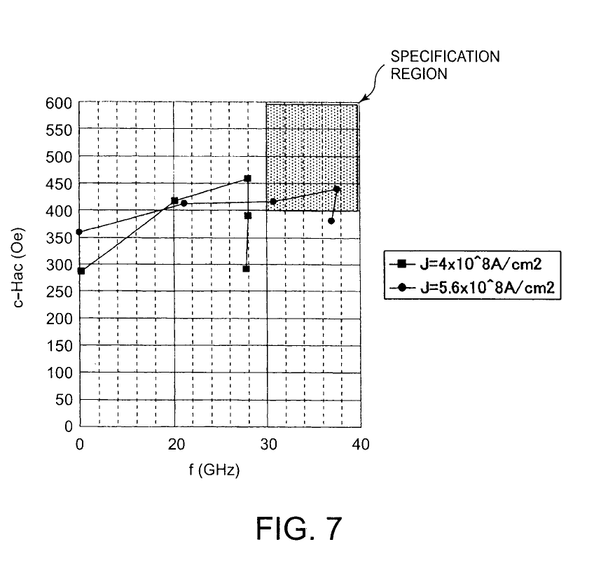

FIG. 7 is a graph showing a simulation for current-density dependence of a relation between an oscillation frequency inside STO 10 and the RF magnetic field generated by STO 10. The current-density dependence is simulated on the magnetic recording head 60 provided with STO 10 according to the first embodiment. The vertical and horizontal axes represent RF magnetic field c-Hac (Oe) and the oscillation frequency f (GHz), respectively.

The second example is different from the first example in that a 3-nm thick FeCo layer is employed for the oscillation layer 10a, and a lamination film with a 0.2-nm thick Co layer and a 0.6-nm thick nickel layer laminated alternately 14 times is employed for the oscillation layer 10b. The lamination film provides the oscillation layer 10b with magnetic anisotropy of 3 kOe.

In this case, passing a current density of 5.6×10⁸ A/cm² through STO 10 provides an RF magnetic field c-Hac (Oe) and an oscillation frequency f (GHz) both belong to the specification region.

### Comparative Example

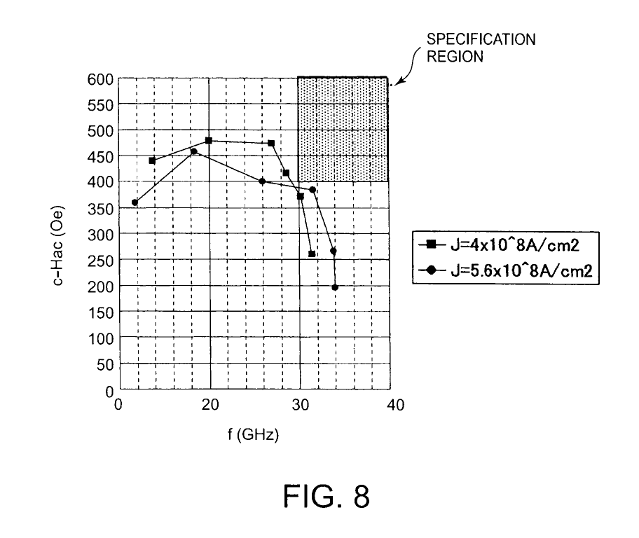

FIG. 8 is a graph showing a simulation for current-density dependence of a relation between an oscillation frequency inside STO and the RF magnetic field generated by STO. The current-density dependence is simulated on a magnetic recording head which is provided with STO.

The comparative example is different from the first and second examples in that a 17 nm thick FeCo layer is employed for the oscillation layers 10a, 10b. In this case, even passing a current density of 5.6×10⁸ A/cm² through STO cannot provide the field and the frequency both belong to the specification region.

Consequently, it is shown that the drive current can be reduced by using STO 10 according to the embodiments.

### Third Embodiment

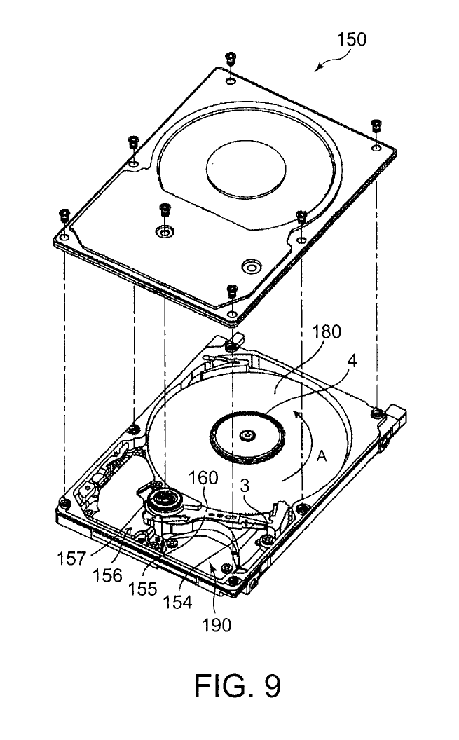

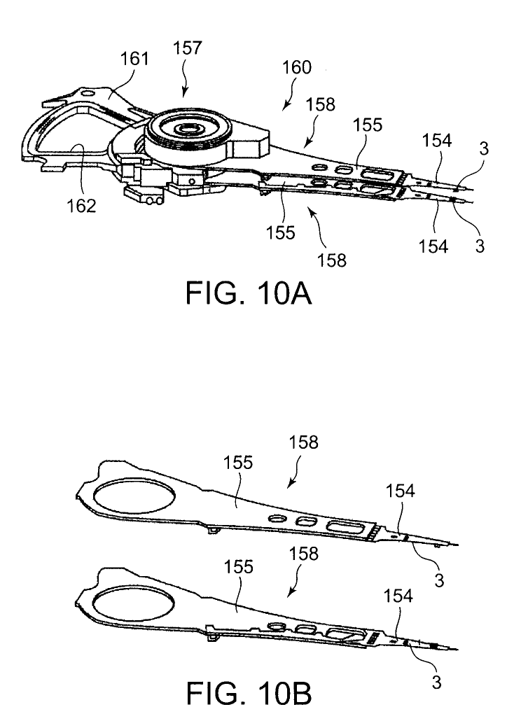

FIG. 9 is a view showing a magnetic recording/reproducing apparatus 150 according to a third embodiment. FIG. 10 is a view showing a portion of the magnetic recording/reproducing apparatus 150 according to the third embodiment.

As shown in FIG. 9, the magnetic recording/reproducing apparatus 150 according to this embodiment is a system employing a rotary actuator. In FIG. 9, a spindle motor 4 is provided with a recording medium disk 180, and rotates in a direction shown by the arrow “A” in response to a control signal from a drive controller (not shown). Alternatively, the magnetic recording/reproducing apparatus 150 according to this embodiment may be provided with two or more recording medium disks 180.

The head slider 3 carries a magnetic recording head to perform recording/reproducing information to be stored in the recording medium disk 180, and has the composition mentioned above. The head slider 3 is mounted on the tip of a filmy suspension 154. The magnetic recording head carries any one of the magnetic recording heads 110 according to the first and second embodiments at the tip thereof.

The recording medium disk 180 rotates so that a pressing load due to the suspension 154 is balanced with a force generated on the air-bearing surface of the head slider 3, thereby suspending the air-bearing surface of the head slider 3 above the surface of the recording medium disk 180 with a prescribed flying height. Alternatively, the head slider 3 may be rotated in contact with the recording medium disk 180, which is called a “contact run type”.

The suspension 154 is connected to one end of an actuator arm 155 having a bobbin, etc. holding a drive coil (not shown). The other end of the actuator arm 155 is provided with a voice coil motor 156, i.e., a kind of a linear motor. The voice coil motor 156 can include a drive coil (not shown) and a magnetic circuit. The drive coil is wound up onto the bobbin of the actuator arm 155. The magnetic circuit includes a permanent magnet and a facing yoke to put in the coil so that the coil passes through the central portion of the yoke.

The actuator arm 155 is suspended by ball bearings which are provided on both the upper and lower sides of a bearing portion 157, and can rotate slidably owing to the voice coil motor 156. As a result, it is possible to move the magnetic recording head to an arbitrary position of the recording medium disk 180.

FIG. 10A is a perspective view illustrating a composition of a portion of the magnetic recording/reproducing apparatus according to the third embodiment to enlarge a head stack assembly 160.

FIG. 10B is a perspective view illustrating a magnetic head stack assembly (head gimbal assembly referred to as “HGA”) 158 to compose a portion of the head stack assembly 160.

As illustrated in FIG. 10A, the head stack assembly 160 has the bearing portion 157, a head gimbal assembly (HGA) 158 extending from the bearing portion 157, and a suspension flame 161 which extends from the bearing portion 157 in a direction opposite to HGA and suspends a coil 162 of the voice coil motor.

As shown in FIG. 10B, the head gimbal assembly 158 has the actuator arm 155 extending from the bearing portion 157 and the suspension 154 extending from the actuator arm 155.

A head slider 3 is mounted onto the tip of the suspension 154. Then, either of the magnetic recording heads according to the first and second embodiments is carried by the head slider 3.

The magnetic head assembly (head gimbal assembly) 158 according to the embodiment is provided with the magnetic recording head according to the first or second embodiment, the head slider 3 carrying the magnetic recording head, the suspension 154 carrying the head slider 3 on one end thereof, and the actuator arm 155 connected to the other end of the suspension 154.

The suspension 154 has a lead for write-in/read-out of signals, a lead for a heater to control the flying height and a lead (not shown) for the oscillation of STO 10. These leads are electrically connected to the respective electrodes of the magnetic recording head 110 to be built into the head slider 3. In addition, electrode pads (not shown) are provided in the head gimbal assembly 158. The “electrode pads” are referred to as the “pads” simply below. Eight pads are provided for this example. That is, the head gimbal assembly 158 is provided with two pads for the coils of the magnetic pole 61, two pads for the magnetic reproducing element 71, two pads for DFH (dynamic flying height), and two pads for STO 10.

Then, a signal processor 190 is also provided to perform write-in/read-out of signals on/from the magnetic recording medium using the magnetic recording head. The signal processor 190 is mounted onto the back side of the drawing of the magnetic recording/reproducing apparatus 150 illustrated in FIG. 9, for example. Input-output lines are connected to the pads of the head gimbal assembly 158, and coupled electrically with the magnetic recording head.

Thus, the magnetic recording/reproducing apparatus 150 according to this embodiment is provided with the magnetic recording medium, one of the magnetic recording heads of the first and second embodiments, a movable portion, a position controller and a signal processor. The movable portion enables the magnetic recording head to relatively move to the magnetic recording medium while making the magnetic recording head fly above or in contact with the magnetic recording medium and making the magnetic recording medium and the magnetic recording head face each other. The position controller arranges the magnetic recording head at a prescribed position on the magnetic recording medium. The signal processor performs write-in/read-out of signals on/from the magnetic recording medium.

That is, the recording medium disk 180 is employed as the magnetic recording medium mentioned above.

The above-mentioned movable portion can include the head slider 3.

The above-mentioned position controller can also include the head gimbal assembly 158.

That is, the magnetic recording/reproducing apparatus 150 according to this embodiment is provided with the magnetic recording medium, the magnetic head assembly according to the third embodiment and the signal processor 190 to perform write-in/read-out of signals on/from the magnetic recording medium using the magnetic recording head mounted onto the magnetic head assembly.

According to the magnetic recording/reproducing apparatus 150 of this embodiment, the magnetic recording head according to the first or second embodiment allows it to provide a magnetic recording/reproducing apparatus capable of performing stable RF field-assist recording with high recording density.

In the magnetic recording/reproducing apparatus according to the third embodiment, STO 10 can be arranged on a trailing side of the magnetic pole 61. In this case, a magnetic recording layer 81 of the magnetic recording medium 80 first faces the magnetic pole 61, and then faces STO 10.

STO 10 can be arranged on the leading side of the magnetic pole 61. In this case, the magnetic record layer 81 of the magnetic recording medium 80 first faces STO 10, and then faces the magnetic pole 61.

The magnetic recording medium for the magnetic recording/reproducing apparatus of the third embodiment is explained below.

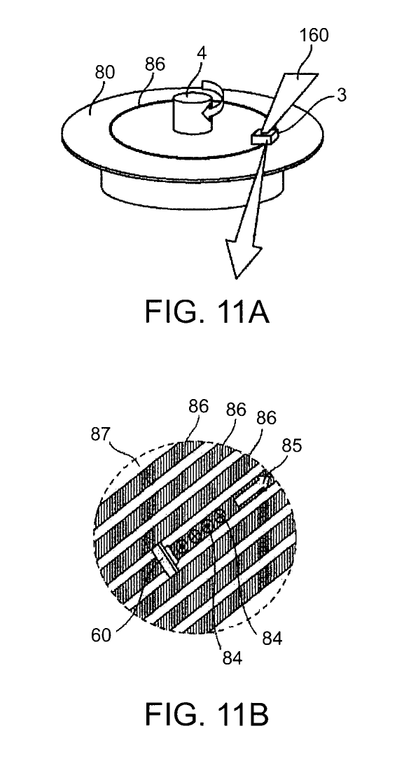

FIGS. 11A and 11B are typical perspective views illustrating compositions of the magnetic recording medium for the magnetic recording/reproducing apparatus according to the third embodiment.

As shown in FIGS. 11A and 11B, the magnetic recording medium 80 employed for the magnetic recording/reproducing apparatus according to the third embodiment has magnetic discrete tracks (recording tracks) 86 including magnetic grains which are separated from each other by a nonmagnetic material (or air) 87. The magnetic grains have magnetization directions substantially perpendicular to the medium surface. When this magnetic recording medium 80 is rotated by the spindle motor 4 and moves in a medium moving direction 85, one of the magnetic recording heads according to the first or second embodiment is employed to thereby form a recorded region 84 of magnetization.

Thus, in the magnetic recording/reproducing apparatus according to the third embodiment, the magnetic recording medium 80 can be a discrete track medium where the adjacent recording tracks are formed to be separated from each other by the nonmagnetic portions.

The width (TS) of STO 10 in the track width direction is set to not narrower than the width (TW) of the tracks 86 and not larger than the recording track pitch. This setting allows it to control a reduction in the coercivity of the adjacent recording tracks due to a leaked RF magnetic field from STO 10. For this reason, in the magnetic recording medium 80 of this example, RF field-assist recording can be focused just on a targeted track to be recorded.

According to this example, it is easier to enable the RF field-assist recording apparatus for narrow track recording rather than to use a perpendicular magnetic recording medium including magnetic grains, i.e., an unprocessed continuous medium. According to a conventional magnetic recording method, it was impossible to use FePt, SmCo, etc. as magnetic fine grains, because the magnetic fine grains of FePt, SmCo, etc. having extremely high magnetic anisotropy energy (Ku) were too hard to switch the magnetization direction thereof, i.e., to write in.

The magnetic recording/reproducing apparatus according to the third embodiment is capable of firmly recording even on the discrete type magnetic recording medium 80 having a high coercivity, thereby allowing it to perform high-density and high-speed recording.

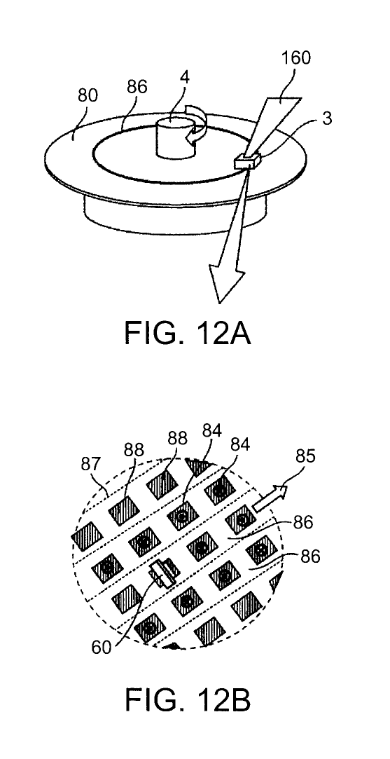

FIGS. 12A and 12B are typical perspective views illustrating compositions of another magnetic recording medium of the magnetic recording/reproducing apparatus according to the third embodiment.

As illustrated in FIGS. 12A and 12B, another magnetic recording medium 80 for the magnetic recording/reproducing apparatus according to the third embodiment has magnetic discrete bits 88 separated from each other by a nonmagnetic material 87. When this magnetic recording medium 80 is rotated by the spindle motor 4 and moves in the medium moving direction 85, the magnetic recording head according to the embodiment can form a recorded region 84 of magnetization.

Thus, the magnetic recording medium 80 can be a discrete bit medium (often referred to also as “bit patterned medium”) of which recording magnetic dots are separated from each other by the nonmagnetic portions to be regularly arranged on the magnetic recording medium according to the third embodiment.

The magnetic recording/reproducing apparatus according to the third embodiment is capable of firmly recording even on the discrete type magnetic recording medium 80 with a high coercivity, allowing it to perform high-density and high-speed recording.

The width (TS) of STO 10 in the track width direction is set to not narrower than the width (TW) of the tracks 86 and not larger than the recording track pitch. This setting allows it to control a reduction in the coercivity of the adjacent recording tracks due to a leaked RF magnetic field from STO 10. For this reason, in the magnetic recording medium 80 of this example, RF field-assist recording can be focused just on a targeted track to be recorded.

According to this example, enhancing the anisotropy energy (Ku) and miniaturizing the magnetic discrete bits 88 possibly provide an RF field-assist recording apparatus having a high recording density of 10 Tbits/inch² or more, as long as the heat fluctuation tolerance of the bits 88 is maintained under the usage environment thereof.

As described above, according to the first embodiment, a magnetic recording head includes a first ferromagnetic layer, an intermediate layer, a third ferromagnetic layer, a first magnetic pole and a second magnetic pole. The intermediate layer is provided between the first ferromagnetic layer and the second ferromagnetic layer. The third ferromagnetic layer includes a CoIr alloy and is provided so that the first ferromagnetic layer is sandwiched between the third ferromagnetic layer and the intermediate layer. The first magnetic pole is provided so that the third ferromagnetic layer is sandwiched between the first magnetic pole and the first ferromagnetic layer. The second magnetic pole is provided so that the second ferromagnetic layer is sandwiched between the second magnetic pole and the intermediate layer.

According to the first embodiment, another magnetic recording head includes an artificial lattice layer, an intermediate layer, a first ferromagnetic layer, a second ferromagnetic layer, a first magnetic pole and a second magnetic pole. The artificial lattice layer has Fe-containing layers and Co-containing layers laminated alternately. The first ferromagnetic layer is provided between the artificial lattice layer and the intermediate layer. The second ferromagnetic layer is provided so that the intermediate layer is sandwiched between the first ferromagnetic layer and the second ferromagnetic layer. The first magnetic pole is provided so that the artificial lattice layer is sandwiched between the first magnetic pole and the first ferromagnetic layer. The second magnetic pole is provided so that the second ferromagnetic layer is sandwiched between the second magnetic pole and the intermediate layer.

According to the second embodiment, a magnetic recording head includes an antiferromagnetic layer, an intermediate layer, a first ferromagnetic layer, a second ferromagnetic layer, a first magnetic pole and a second magnetic pole. The first ferromagnetic layer is provided between the antiferromagnetic layer and the intermediate layer. The second ferromagnetic layer is provided so that the intermediate layer is sandwiched between the first ferromagnetic layer and the second ferromagnetic layer. The first magnetic pole is provided so that the antiferromagnetic layer is sandwiched between the first magnetic pole and the first ferromagnetic layer. The second magnetic pole is provided so that the second ferromagnetic layer is sandwiched between the intermediate layer and the second magnetic pole.

According to the third embodiment, a magnetic recording head assembly includes the magnetic recording head according to the first embodiment or the second embodiment, a head slider, a suspension and an actuator arm. The head slider carries the magnetic recording head. The suspension carries the head slider at one end thereof. The actuator arm is connected to the other end of the suspension.

According to the third embodiment, a magnetic recording/reproducing apparatus includes a magnetic recording medium, the magnetic recording head according to the first embodiment or the second embodiment, a movable portion, a position controller and a signal processor. The movable portion enables the magnetic recording medium and the magnetic recording head to relatively move to each other with separating the magnetic recording medium and the magnetic recording head from each other or making the magnetic recording medium and the magnetic recording head in contact with each other while making the medium and the head face each other. The position controller arranges the magnetic recording head at a prescribed position on the magnetic recording medium. The signal processor performs write-in of signals on the magnetic recording medium or read-out of signals from the magnetic recording medium.

While certain embodiments of the invention have been described, these embodiments have been presented by way of example only, and are not intended to limit the scope of the inventions. Indeed, the novel elements and apparatuses described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A magnetic recording head comprising:
a first ferromagnetic layer;
a second ferromagnetic layer;
an intermediate layer which is provided between the first ferromagnetic layer and the second ferromagnetic layer;
a third ferromagnetic layer which includes a CoIr alloy and is provided so that the first ferromagnetic layer is sandwiched between the third ferromagnetic layer and the intermediate layer;
a first magnetic pole which is provided so that the third ferromagnetic layer is sandwiched between the first magnetic pole and the first ferromagnetic layer; and
a second magnetic pole which is provided so that the second ferromagnetic layer is sandwiched between the second magnetic pole and the intermediate layer.

2. A magnetic recording head comprising:
an artificial lattice layer having Fe-containing layers and Co-containing layers laminated alternately;
an intermediate layer;
a first ferromagnetic layer which is provided between the artificial lattice layer and the intermediate layer;
a second ferromagnetic layer which is provided so that the intermediate layer is sandwiched between the first ferromagnetic layer and the second ferromagnetic layer; and
a first magnetic pole which is provided so that the artificial lattice layer is sandwiched between the first magnetic pole and the first ferromagnetic layer; and
a second magnetic pole which is provided so that the second ferromagnetic layer is sandwiched between the second magnetic pole and the intermediate layer.

3. A magnetic recording head comprising:
an antiferromagnetic layer;
an intermediate layer;
a first ferromagnetic layer which is provided between the antiferromagnetic layer and the intermediate layer;
a second ferromagnetic layer which is provided so that the intermediate layer is sandwiched between the first ferromagnetic layer and the second ferromagnetic layer;
a first magnetic pole which is provided so that the antiferromagnetic layer is sandwiched between the first magnetic pole and the first ferromagnetic layer; and
a second magnetic pole which is provided so that the second ferromagnetic layer is sandwiched between the intermediate layer and the second magnetic pole.

4. The head according to claim 1, wherein the first ferromagnetic layer includes either Fe or Co.

5. The head according to claim 4, wherein the first ferromagnetic layer includes a body-centered cubic lattice structure.

6. The head according to claim 1, wherein the second ferromagnetic layer includes an artificial lattice layer having Co-containing layers and layers containing an element selected from the group of Ni, Pd and Pt.

7. A magnetic head assembly comprising:
a magnetic recording head;
a head slider carrying the magnetic recording head;
a suspension carrying the head slider at one end thereof; and
an actuator arm connected to the other end of the suspension,
wherein
the magnetic head includes:
a first ferromagnetic layer;
a second ferromagnetic layer;
an intermediate layer provided between the first ferromagnetic layer and the second ferromagnetic layer;
a third ferromagnetic layer which includes a CoIr alloy and is provided so that the first ferromagnetic layer is sandwiched between the third ferromagnetic layer and the intermediate layer;
a first magnetic pole which is provided so that the third ferromagnetic layer is sandwiched between the first magnetic pole and the first ferromagnetic layer; and
a second magnetic pole which is provided so that the second ferromagnetic layer is sandwiched between the second magnetic pole and the intermediate layer.

8. A magnetic head assembly comprising:
a magnetic recording head;
a head slider carrying the magnetic recording head;
a suspension carrying the head slider at one end thereof; and
an actuator arm connected to the other end of the suspension,
wherein
the magnetic head includes:
an artificial lattice layer having Fe-containing layers and Co-containing layers laminated alternately;
an intermediate layer;
a first ferromagnetic layer which is provided between the artificial lattice layer and the intermediate layer;
a second ferromagnetic layer which is provided so that the intermediate layer is sandwiched between the first ferromagnetic layer and the second ferromagnetic layer; and
a first magnetic pole which is provided so that the artificial lattice layer is sandwiched between the first magnetic pole and the first ferromagnetic layer; and
a second magnetic pole which is provided so that the second ferromagnetic layer is sandwiched between the second magnetic pole and the intermediate layer.

9. A magnetic head assembly comprising:
a magnetic recording head;
a head slider carrying the magnetic recording head;
a suspension carrying the head slider at one end thereof; and
an actuator arm connected to the other end of the suspension,
wherein
the magnetic head includes:
an antiferromagnetic layer;
an intermediate layer;
a first ferromagnetic layer which is provided between the antiferromagnetic layer and the intermediate layer;
a second ferromagnetic layer which is provided so that the intermediate layer is sandwiched between the first ferromagnetic layer and the second ferromagnetic layer;
a first magnetic pole which is provided so that the antiferromagnetic layer is sandwiched between the first magnetic pole and the first ferromagnetic layer; and
a second magnetic pole which is provided so that the second ferromagnetic layer is sandwiched between the intermediate layer and the second magnetic pole.

10. A magnetic recording/reproducing apparatus comprising:
a magnetic recording medium;
a magnetic recording head;
a movable portion enabling the magnetic recording medium and the magnetic recording head to relatively move to each other with separating the magnetic recording medium and the magnetic recording head from each other or making the magnetic recording medium and the magnetic recording head in contact with each other while making the medium and the head face each other;
a position controller to arrange the magnetic recording head at a prescribed position on the magnetic recording medium; and
a signal processor to perform write-in of signals on the magnetic recording medium or read-out of signals from the magnetic recording medium,
wherein
the magnetic head includes:
a first ferromagnetic layer;
a second ferromagnetic layer;
an intermediate layer provided between the first ferromagnetic layer and the second ferromagnetic layer;
a third ferromagnetic layer which includes a CoIr alloy and is provided so that the first ferromagnetic layer is sandwiched between the third ferromagnetic layer and the intermediate layer;
a first magnetic pole which is provided so that the third ferromagnetic layer is sandwiched between the first magnetic pole and the first ferromagnetic layer; and
a second magnetic pole which is provided so that the second ferromagnetic layer is sandwiched between the second magnetic pole and the intermediate layer.

11. A magnetic recording/reproducing apparatus comprising:
a magnetic recording medium;
a magnetic recording head;
a movable portion enabling the magnetic recording medium and the magnetic recording head to relatively move to each other with separating the magnetic recording medium and the magnetic recording head from each other or making the magnetic recording medium and the magnetic recording head in contact with each other while making the medium and the head face each other;
a position controller to arrange the magnetic recording head at a prescribed position on the magnetic recording medium; and
a signal processor to perform write-in of signals on the magnetic recording medium or read-out of signals from the magnetic recording medium,
wherein
the magnetic head includes:
an artificial lattice layer having Fe-containing layers and Co-containing layers laminated alternately;
an intermediate layer;
a first ferromagnetic layer which is provided between the artificial lattice layer and the intermediate layer;
a second ferromagnetic layer which is provided so that the intermediate layer is sandwiched between the first ferromagnetic layer and the second ferromagnetic layer; and
a first magnetic pole which is provided so that the artificial lattice layer is sandwiched between the first magnetic pole and the first ferromagnetic layer; and
a second magnetic pole which is provided so that the second ferromagnetic layer is sandwiched between the second magnetic pole and the intermediate layer.

12. A magnetic recording/reproducing apparatus comprising:
a magnetic recording medium;
a magnetic recording head;
a movable portion enabling the magnetic recording medium and the magnetic recording head to relatively move to each other with separating the magnetic recording medium and the magnetic recording head from each other or making the magnetic recording medium and the magnetic recording head in contact with each other while making the medium and the head face each other;
a position controller to arrange the magnetic recording head at a prescribed position on the magnetic recording medium; and
a signal processor to perform write-in of signals on the magnetic recording medium or read-out of signals from the magnetic recording medium,
wherein
the magnetic head includes:
an antiferromagnetic layer;
an intermediate layer;
a first ferromagnetic layer which is provided between the antiferromagnetic layer and the intermediate layer;
a second ferromagnetic layer which is provided so that the intermediate layer is sandwiched between the first ferromagnetic layer and the second ferromagnetic layer;
a first magnetic pole which is provided so that the antiferromagnetic layer is sandwiched between the first magnetic pole and the first ferromagnetic layer; and
a second magnetic pole which is provided so that the second ferromagnetic layer is sandwiched between the intermediate layer and the second magnetic pole.

13. The apparatus according to claim 10, wherein the magnetic recording medium is a discrete track medium where adjacent recording tracks are formed to be separated from each other by nonmagnetic portions on the magnetic recording medium.

14. The apparatus according to claim 10, wherein the magnetic recording medium is a discrete bit medium having recording magnetic dots to be separated from each other by nonmagnetic portions and regularly arranged on the magnetic recording medium.
